(19) United States
(12) Patent Application Publication
(10) Pub. No.: US 2022/0228422 A1
(43) Pub. Date: Jul. 21, 2022

(54) FLASHING FOR A BUILDING OPENING

(71) Applicant: Gabe Coscarella, Edmonton (CA)

(72) Inventor: Gabe Coscarella, Edmonton (CA)

(21) Appl. No.: 17/579,535

(22) Filed: Jan. 19, 2022

Related U.S. Application Data
(60) Provisional application No. 63/139,202, filed on Jan. 19, 2021.

(51) Int. Cl. E06B 1/62; E06B 1/36

(52) U.S. Cl. CPC E06B 1/62; E06B 2001/628; E06B 1/36

(57) ABSTRACT

Flashing for a building profile is formed using a flexible sheet of impermeable material. The flexible sheet has one or more fold lines extending in a first direction and spaced across the flexible sheet in a second direction that is perpendicular to the first direction. The one or more fold lines are defined by an increased flexibility relative to the flexibility of the flexible sheet.

### TECHNICAL FIELD

This relates to flashing for a building opening, such as a window or a door, and in particular, flexible flashing

### BACKGROUND

New constructions, such as residential homes, often require a building envelope that is weatherproof. The building will have a variety of protrusions and openings through the wall, such as doors and windows. It is often required to seal around these protrusions as part of the building envelope. United States Patent Application Publication No. 2014/0250801 (Knollmeyer) entitled “Kit and components for a flashing installation” teaches a set of components used to seal around a window opening to prevent water penetration.

### SUMMARY

According to an aspect, there is provided flashing for a building profile, comprising a flexible sheet of impermeable material, the flexible sheet having one or more fold lines extending in a first direction and spaced across the flexible sheet in a second direction that is perpendicular to the first direction, the one or more fold lines being defined by an increased flexibility relative to the flexibility of the flexible sheet.

According to other aspects, the flashing may comprise one or more of the following features: the one or more fold lines may define a profile section that, when folded, defines a non-planar profile, and the profile section may comprise a central fold line, a first fold line, and a second fold line disposed on an opposite side of the central fold line relative to the first fold line; the flexible sheet may be integrally formed as a single piece of flexible material, and the one or more fold lines may be formed by applying a localized force to deform the flexible sheet; the one or more fold lines may be defined by a deformation of the flexible sheet and/or a reduced thickness relative to an adjacent portion of the flexible sheet; the one or more fold lines may comprise one or more side edge fold lines that engage one or more edges of a building opening; and the one or more fold lines may further comprise one or more corner fold lines that extend along the second direction of the flexible sheet.

A method of forming flashing for a building opening, the method comprising: providing a flexible sheet of impermeable material; and forming one or more fold lines in the flexible sheet, the one or more fold lines extending in a first direction and being spaced across the flexible sheet in a second direction that is perpendicular to the first direction, the one or more fold lines being defined by increased flexibility relative to the flexibility of the flexible sheet.

According to other aspects, the method may comprise one or more of the following features: the one or more fold lines may define a profile section, and the method may further comprise the step of folding the profile section to define a non-planar profile; the profile section may comprise at least a central fold line, and a first line and a second fold line disposed on opposite sides of the central fold line that permit the flexible sheet to form a non-planar profile; the flexible sheet may be integrally formed as a single piece of flexible material, and forming the one or more fold lines comprises applying localized pressure to deform the flexible sheet; the one or more fold lines may comprise one or more side edge fold lines spaced to correspond with an edge of a building opening when installed; the method may further comprise bending the flexible sheet to form a 90-degree angle along a corner fold line that extends along the second direction of the flexible sheet to fit a corner of the building opening; the method may further comprise cutting the flexible sheet along a portion of the corner fold line, or along a line that intersects with the corner fold line; the method may further comprise providing a second flexible sheet having a complementary 90-degree angle that overlies the flexible sheet at the corner of the building opening; the method may further comprise forming a first cut along a portion of a central fold line and a second cut along a corner fold line, the first cut intersecting the second cut at a substantially perpendicular angle at the 90-degree angle to form an opening; and receiving the upstanding V on an adjacent portion of the 90-degree angle within the opening.

Other aspects will be apparent from the description and the claims below.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of flashing installed in a window and an additional corner cover.

FIG. 2a-2k are side elevation views in section of alternative fold line arrangements and corresponding profiles.

FIG. 3 is a side elevation view in section of a sheet of flexible material.

FIG. 4 is an exploded perspective view of a defined length of flashing material and a die.

FIG. 5 is a perspective view of an indefinite length of flashing material passing through a die.

FIG. 6 is a side elevation view of a die used to form the fold lines of the flashing material.

FIG. 7a-7f are side elevation views in section of alternative fold lines.

FIG. 8a is a front elevation view of flashing in an opening for a window.

FIG. 8b is a front elevation view of flashing in an opening for a window.

FIG. 9 is a perspective view of a multi-part flashing.

FIG. 10 is a top plan view of flashing for a corner of an opening with defined lines.

FIG. 11 is a perspective view of flashing folded to fit in an opening.

FIG. 12 is a perspective view of an alternative flashing folded to fit in an opening.

### DETAILED DESCRIPTION OF PREFERRED EMBODIMENTS

Flashing for a building opening, a method of manufacturing the flashing, a method of using the flashing, and a combination of flashing with a building and the building envelope will now be described with reference to the drawings, which are for the purpose of illustration only and are not intended to be in any way limiting.

While the discussion below is primarily in terms of flashing installed for a window, the flashing may also be used for other building openings, such as doors. An opening is typically characterized by bottom, side and top surfaces that are orthogonally oriented relative to the building's inner wall surface and outer wall surface. As the terms are used herein, the corners of the opening are at the intersections between the side surfaces and the bottom and top surfaces, and the edges of the opening are at the intersections of the bottom, side, and top surfaces and the inner wall surface and the outer wall surface. Flashing is primarily useful on the bottom surface of the opening and the corners at either end of the bottom surface, where water egress is most likely to occur. However, the flashing may be installed on any suitable surface of the building opening.

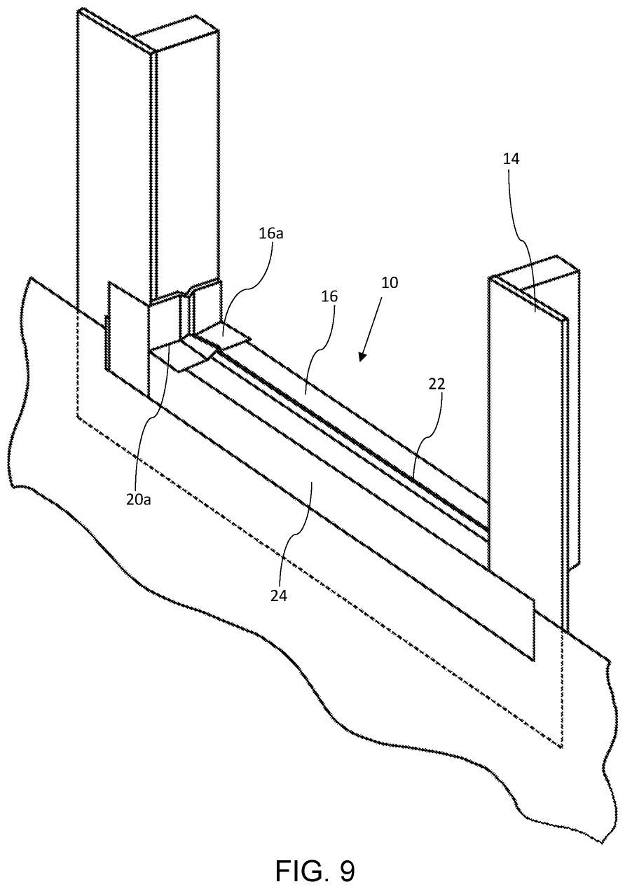

The flashing described herein may be made from a flexible material that folds along fold lines and may be sufficiently flexible to form 90 degree angles, or doubled over, either along a fold line or elsewhere. The flexible material may be a sheet of polyethylene material or other suitable material, that is thick enough to provide sufficient durability, while still being thin enough to be manipulated as required. The fold lines are useful to accommodate an outer corner, to define a surface profile, and/or an inside corner, such as where horizontal and vertical surfaces of an opening meet. The flashing is designed to tie in with a weather barrier used to create a building envelope, such as a building wrap materials such as Tyvek™, a sheathing system, or similar products. As shown in FIG. 9, this will typically involve shingling the flashing and weather barrier (shown as building wrap), such that water runs down over the overlying layer of material draped over the underlying layer and therefore away from the underlying surface. In some cases, other types of fasteners, such as staples, tape, etc. may also be used to install the flashing and tie it in to the building wrap. The flashing is preferably large enough to cover the building opening being protected with sufficient overlap to cover the building wrap material.

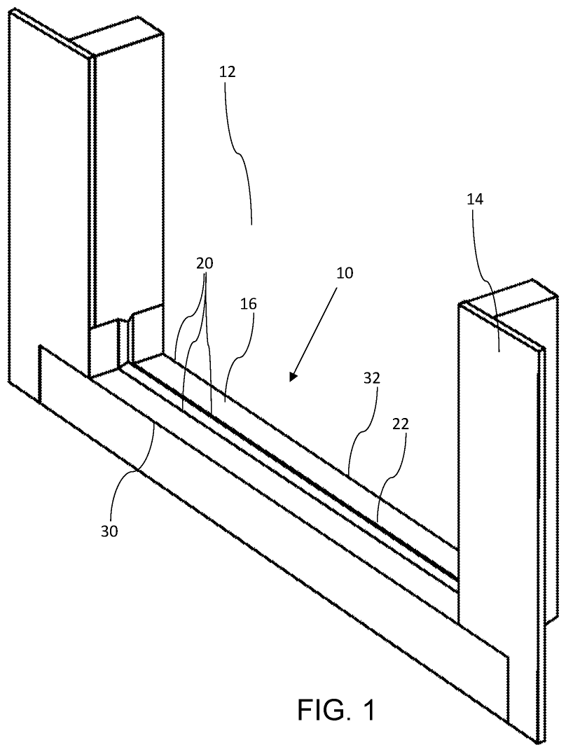

Referring to FIG. 1, there is shown an example of flashing 10 installed in an opening 12 of a building wall 14. Flashing 10 in this example is a single piece that extends across the width of opening 12, and may be referred to as a sill cap.

Flashing 10 is made from a flexible sheet 16 having a length, a width, and a thickness. While there may be more than one sheet used in a given installation, each sheet of flashing 10 may be formed as a single piece of flexible material. It will be understood that, while flashing 10 is discussed in terms of an elongate, rectangular body, the flashing may also be made with different shapes and sizes that may be non-rectangular. The length and width of flexible sheet 16 is generally considered from the perspective of the opening in which flashing 10 is installed, where the length of sheet 16 extends along the inner surface of the opening, and the width folds over the front and/or back edge 30/32 of the inner surface.

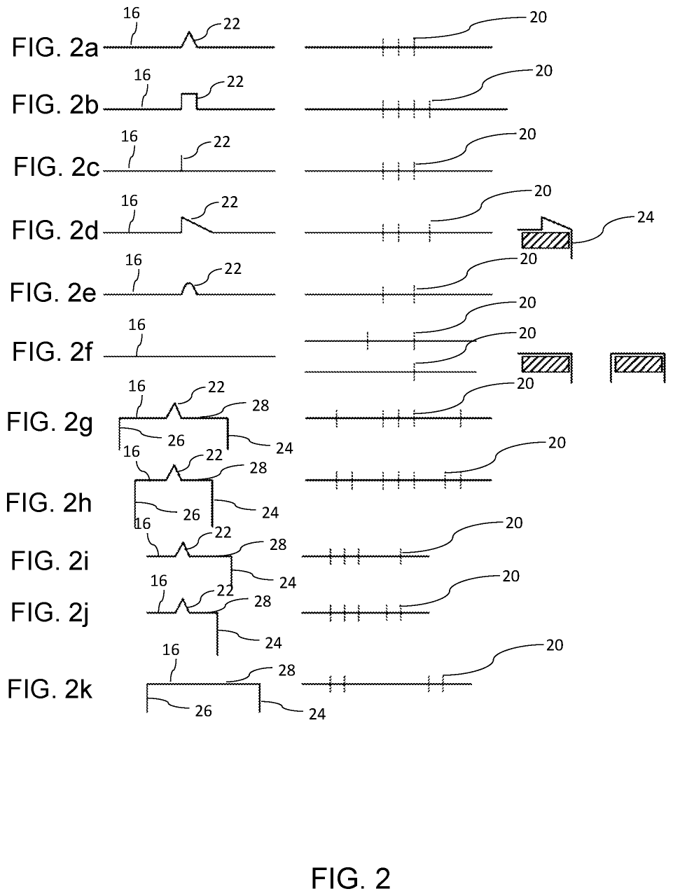

Flexible sheet 16 is formed with a series of fold lines 20 that extend along the length of flexible sheet 16 and are spaced across the width of flexible sheet 16 that allow the sheet of material to be folded to conform to the shape of opening 12. Fold lines 20 may be defined by an area of increased flexibility relative to the flexibility of the rest of flexible sheet 16 and correspond with suitable locations for folds. The series of fold lines 20 may include one or more fold lines 20 that extend along the length of flexible sheet 16 and may be used to facilitate installation in a building opening 12. The series of fold lines 20 may be designed to form a surface profile 22 such as to increase rigidity, prevent water egress along the sill, etc. when folded and installed. Examples of potential fold profiles are shown FIG. 2. The rigidity of the flashing will typically increase around a fold. By appropriate design, this may be used to increase rigidity at desired locations or in desired profiles using one or more folds. For example, the separation between adjacent fold lines, when more than one fold line 20 is present, may be used to provide a desired rigidity to the flashing, as will be apparent from the example profiles shown below. In some examples, the series of lines 20 may include a front line that allows the flashing to fold down over an edge, typically front edge 30 of opening 12, alone or in combination with a rear line that allows the flashing to fold down over a parallel edge of the sill, in which case the flashing would overlie both the front and rear edges of the sill. In other examples, the series of lines may allow the flashing to form a non-planar surface profile that helps prevent the egress of water. This may be done by using fold lines 20 to form a surface profile 22 such as a slope, dam, or other upstanding structure as shown in the examples in FIG. 2a-2i, or to form a trough or other structure that extends downward. In some cases, a trough (not shown) may be formed by folding sheet 16 around folds 20 in an opposite direction relative to what is shown. Fold lines 20 may be used alone or in combination with the front and rear edge fold lines that define a front portion 24 and/or a rear portion 26 relative to a central portion 28. Surface profile 22 may be formed in central portion 28 as shown. Surface profile 22 may also be formed in front and/or rear portions 24/26. Further, as openings 12 may have a standard width, fold lines 20 may be positioned and spaced to accommodate a desired opening size, while still retaining sufficient flexibility to accommodate small variations.

Referring to the examples depicted, FIG. 2a depicts surface profile 22 as an inverted V formed from three fold lines 20; FIG. 2b as a rectangular shape formed from four fold lines 20; FIG. 2c as a narrow flange formed from three fold lines 20 with the two outside lines pressed close together; and FIG. 2d as a ramp shape formed from three fold lines 20. In these examples, fold lines 20 are used to form a surface that includes an inverted V, or a 90-degree surface as shown, where the arms of the “V” are either widely or closely spaced. Surface profile 22 may be adjustable to allow flexible sheet 16 to accommodate small variations in expected dimensions of openings 12. Fold lines 20 may be designed to account for the front or rear edges of the opening in which flashing 10 installed. For example, the slope of surface profile 22 shown in FIG. 2d may be designed to terminate at front portion 24 of sheet 16. Referring to FIG. 2e, it may also be possible to design sheet 16 to bend between fold lines 20. In this example, two lines 20 are used to form a rounded shape as lines 20 by moving lines 20 close enough to cause the portion of sheet 16 between lines 20 to bend outward. Referring to FIGS. 2e and 2f, sheet 16 may be designed such that central portion 28 is the same width as an opening 12 that has a predetermined width, such as a 6″ wide sill in FIG. 2e, or, referring to FIG. 2f, to accommodate different widths, such as by providing fold lines 20 that accommodate both a 4″ wide sill and a 6″ wide sill, for example, depending on the expected sizes. Referring to FIGS. 2g and 2h, lines 20 may be provided to accommodate only the front or rear edge of a sill while still forming a surface profile and may be provided with lines that accommodate different widths of sills as shown specifically in FIG. 2h. Referring to FIG. 2i, sheet 16 may be provided with lines 20 spaced to permit sheet 16 to be installed either with a surface profile or flat on a sill or opening.

In some examples, sheet 16 may be treated to induce or encourage the material to fold or bend in the desired manner. For example, a score line may be formed on opposite sides of sheet 16 such that lines 20 are more likely to fold in a desired direction. Alternatively, sheet 16 may be designed such that the space between fold lines 20, which may not be intended to bend, are stiffened relative to fold lines 20 in addition to or instead of making fold lines 20 more likely to bend. The fold lines 20 may be positioned at any desired location such that surface profile 22 is located at a desired position relative to the front and rear edges of opening 12.

Flexible sheet 16 may lie flat or may be rolled onto a roll, such as during transport or storage. Prior to installation, flexible sheet 16 may be unrolled, flattened, and/or cut to length as needed. Flexible sheet 16 may then be folded to form surface profile 22, such as an upstanding “V” shape along its length, to act as a dam. Surface profile 22 may be suitably spaced from front and rear edges 30/32 of opening 12. When the insert is installed, such as a window or door, the dam may be high enough that the insert may press down on the dam to create a barrier. Flexible sheet 16 may be formed form a material that is sufficiently flexible, such as a soft plastic that may be polyethylene, or another suitable material, that the pressure of the insert is able to deform the dam to form a seal or if not, at least a barrier sufficient to prevent water egress from the outer wall toward the inner wall. Alternatively, the dam may be behind the insert, in which case it may flex laterally to accommodate the insert, rather than compress vertically.

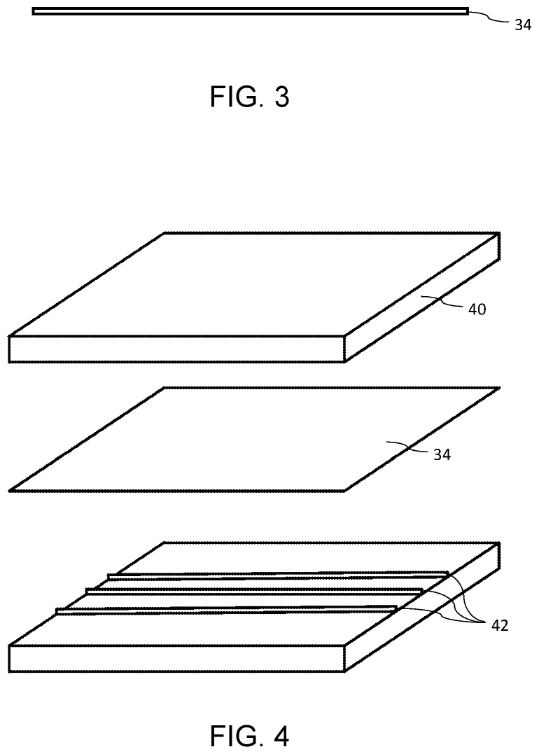

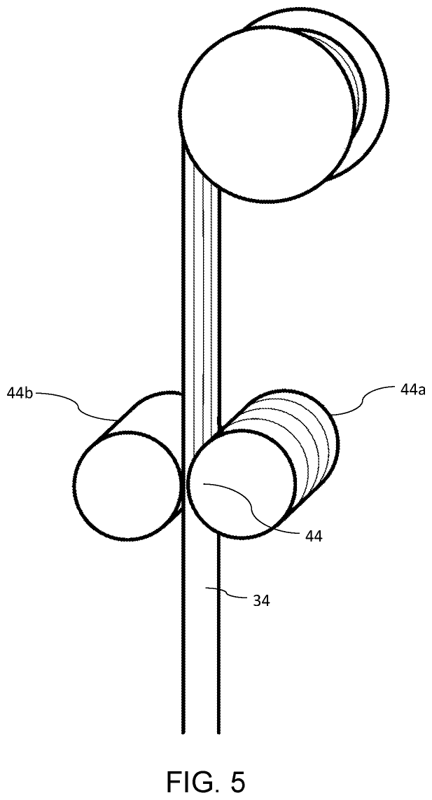

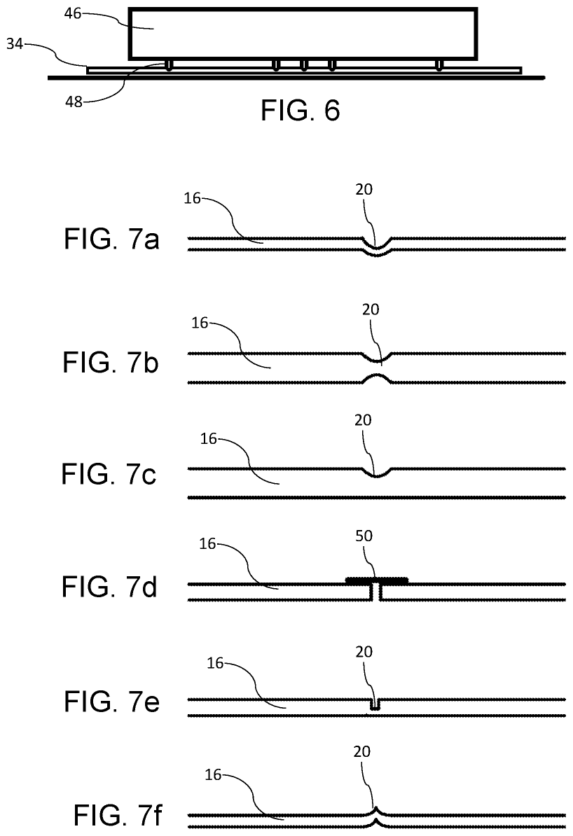

In one example, and as shown in FIG. 1, flexible sheet 16 may be formed from a single piece of material starting from a “blank” sheet of material 34 as shown in FIG. 3, where fold lines 20 are then applied to the material 34, which may be done in various ways. Blank sheet of material 34 may be a defined length as shown in FIG. 3 or may be a continuous length as shown in FIG. 5. Referring to FIG. 4, in the case of a defined length, fold lines 20 may be formed by applying localized pressure to plastically deform sheet of material 34 onto a form or die 40 with upstanding flanges 42. Alternatively, referring to FIG. 5, material 34 may be passed through a roller system 44 with rollers 44a and 44b on opposite sides of material 34 that crease material to form fold lines 20 with the desired spacing. Roller system 44 may also incorporate cutting rollers (not shown) that trim the width of material 34, if desired. Referring to FIG. 6, a die 46 is shown with narrow wheels 48 spaced according to the desired spacing of fold lines 20 that crease material 34 and form fold lines 20. Other designs may be used to form fold lines 20 in the desired manner, such as by pressing material 34 from the top, bottom, or both the top and the bottom, either by rollers, fixed flanges, or the like. In other examples, material 34 may be folded, such as by using a folding system involving rollers (not shown) and then pressed to crease material 34, and then either unfolded or maintained in a folded state to be unfolded by the user at the point of use. Fold lines 20 may also be formed by scoring one or both sides of the flexible sheet to a sufficient depth in the thickness of the material.

As noted, fold lines 20 may take different forms, such as through plastic deformation or by molding, examples of which are shown in FIG. 7a-7e. Fold line 20 may involve the removal, displacement, cutting, thinning, stretching, etc. of material to achieve the desired fold line 20 and to allow the material of flexible sheet 16 to be folded in a consistent and predictable manner. In

FIG. 7a, fold line 20 is formed in flexible sheet 16 by creating a discontinuity in the sheet. The thickness may or may not remain substantially constant, depending on how the discontinuity is formed. In FIG. 7b, fold line 20 is formed by reducing the thickness of flexible sheet 16 from top and bottom. In FIG. 7c, fold line 20 is formed by reducing the thickness of flexible sheet 16 from one side. In FIG. 7d, flexible sheet 16 is formed from separate sections of material that are connected by a flexible membrane 50, such as a sheet of rubber, tape, etc. In FIG. 7e, fold line 20 is formed by scoring flexible sheet 16. In FIG. 7f, fold line 20 is shown as a crease, such as may be formed by pressing on sheet 16 while folded.

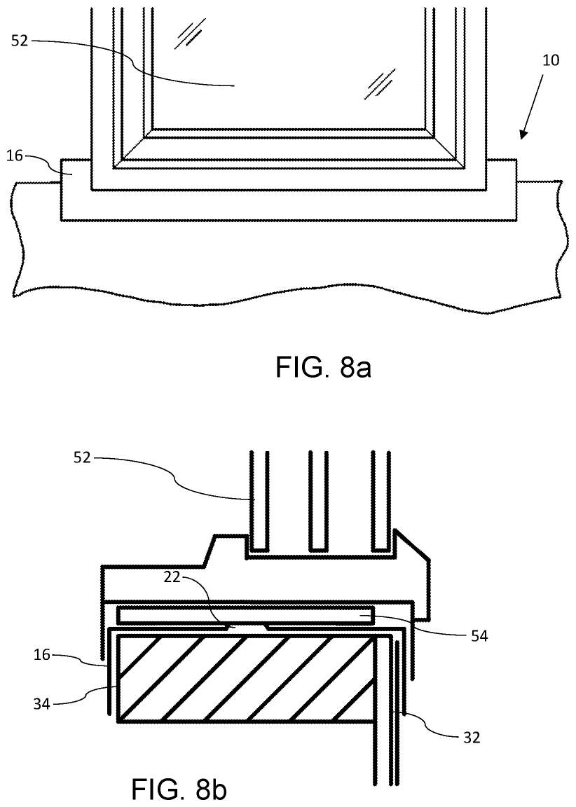

Referring to FIG. 8a, an example of the flashing installed in a window 52 is shown. Referring to FIG. 8b, a shim 54 may be included above or below flexible sheet 16 to support window 52 as shown, or a door as the case may be.

Referring to FIG. 1, flexible sheet 16 may be folded along its width in order to fit into a corner. Referring to FIG. 9, this may be done by providing flexible sheet 16, or a second flexible sheet 16a as in the depicted example, with transverse fold lines 20a that extend along the width of flexible sheet 16, i.e., transverse to fold lines 20. Referring to FIG. 9, an example is shown in which a second flexible sheet 16a is provided for overlying the primary flexible sheet 16 in a corner of opening 12. This helps ensures that any opening in the material or space that results during installation is covered, such that water is prevented from egressing into a building past flashing 10.

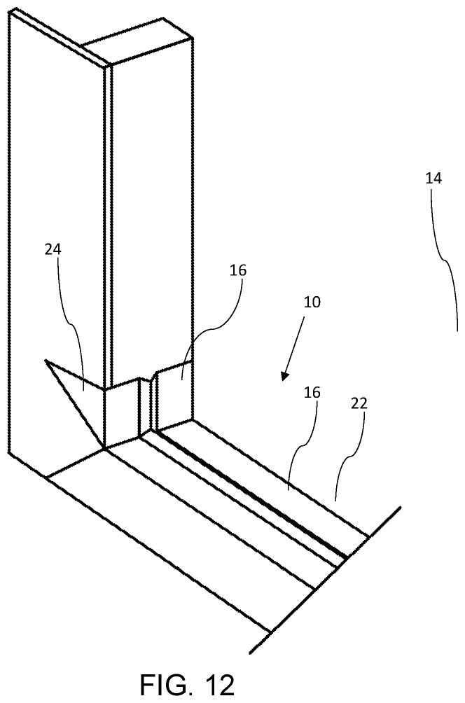

Referring to FIG. 8, flexible sheet 16 may be permitted to fold by cutting the side portions 24/26 at an angle, such as a 45-degree angle as shown in FIG. 12, or along fold lines 20, as shown in FIG. 11 to form a 90-degree angle. In this case, an additional piece of material, such as a second flexible sheet 16a (as shown in FIG. 9) or a piece of tape 58 (not shown), may be installed to cover the cut formed in flexible sheet 16 to ensure water is properly shed from opening 12.

As shown in FIG. 9, when a second piece of material 16a is included as a corner insert, it may be installed as a corner overlay or underlay relative to flexible sheet 16. The folded portion of corner insert 16a may also be cut at a 90-degree angle, but perpendicular to the underlying piece of flashing so that the cuts do not overlap. Corner insert 16a may be formed with the same fold line patterns as flexible sheet 16, and, referring to FIG. 11, may include additional cut lines 60 that align with existing lines 20 and 20a perpendicularly to assist in forming corner insert 16a.

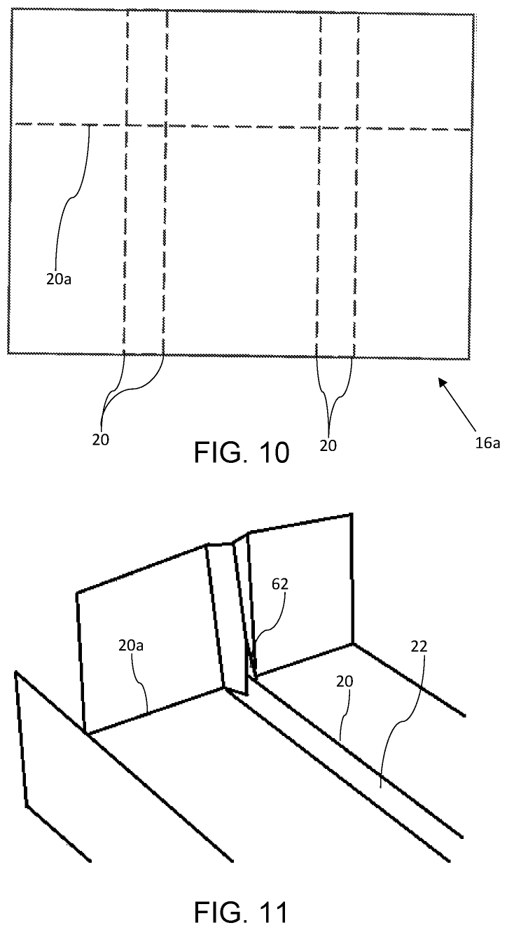

When installing flexible sheets 16 and 16a, it may be useful to provide an adhesive layer (not shown) on the back or front. Such an adhesive layer may be applied immediately prior to installation, may be covered by a removable layer of backing material that is removed to expose the adhesive, may be activated by water, etc. The adhesive may be used to anchor flexible sheets 16 and/or 16a in place either relative to opening 12 or other flexible sheets. The dotted lines in FIG. 10 may represent fold lines 20/20a or may represent cut lines along which a user may cut flexible sheet 16/16a to allow the sheet to be folded to conform to a corner. If it is intended to cut along the lines, they may be perforated, however this may present a point of egress and may not be preferred in situations where it is possible that the sheet may not be cut along the line.

Referring to FIG. 11, surface profile 22 may cause interference when folded into a corner of opening 12. As such, a portion of central fold line 20 and a portion of transverse line 20a may be cut to form an opening 62 that accommodates an adjacent portion of surface profile 22.

The cuts may be pre-formed or formed at the time of installation. The problem may also be avoided by providing a flat corner insert, such that the dam is only formed in the piece that extends along the sill. Flexible tape (not shown) may be used if there is concern of water egress through the cuts.

As will be understood, flashing 10 may be sized to fit within a pre-determined size of opening 12 or flashing 10 may be formed from a roll that allows for an indefinite length and is cut to size. The width of flashing 10 may be designed to fit a standard width or widths of opening, and the folds used to form surface profile 22 may be used to accommodate some variation in the actual width. Different widths may also be accommodated by providing additional fold lines as described above. Similarly, the cuts that allow the flashing to fit in a corner of the opening may be pre-formed or formed at the time of installation.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. Flashing for a building profile, comprising:
a flexible sheet of impermeable material, the flexible sheet having one or more fold lines extending in a first direction and spaced across the flexible sheet in a second direction that is perpendicular to the first direction, the one or more fold lines being defined by an increased flexibility relative to the flexibility of the flexible sheet.

2. The flashing of claim 1, wherein the one or more fold lines defines a profile section that, when folded, defines a non-planar profile.

3. The flashing of claim 2, wherein the profile section comprises a central fold line, a first fold line, and a second fold line disposed on an opposite side of the central fold line relative to the first fold line.

4. The flashing of claim 1, wherein the flexible sheet is integrally formed as a single piece of flexible material.

5. The flashing of claim 4, wherein the one or more fold lines are formed by applying a localized force to deform the flexible sheet.

6. The flashing of claim 1, wherein the one or more fold lines are defined by a deformation of the flexible sheet and/or a reduced thickness relative to an adjacent portion of the flexible sheet.

7. The flashing of claim 1, wherein the one or more fold lines comprise one or more side edge fold lines that engage one or more edges of a building opening.

8. The flashing of claim 1, wherein the one or more fold lines further comprise one or more corner fold lines that extend along the second direction of the flexible sheet.

9. A method of forming flashing for a building opening, the method comprising:
providing a flexible sheet of impermeable material; and
forming one or more fold lines in the flexible sheet, the one or more fold lines extending in a first direction and being spaced across the flexible sheet in a second direction that is perpendicular to the first direction, the one or more fold lines being defined by increased flexibility relative to the flexibility of the flexible sheet.

10. The method of claim 9, wherein the one or more fold lines defines a profile section, and further comprising the step of folding the profile section to define a non-planar profile.

11. The method of claim 10, wherein the profile section comprises at least a central fold line, and a first line and a second fold line disposed on opposite sides of the central fold line that permit the flexible sheet to form a non-planar profile.

12. The method of claim 9, wherein:
the flexible sheet is integrally formed as a single piece of flexible material; and
forming the one or more fold lines comprises applying localized pressure to deform the flexible sheet

13. The method of claim 9, wherein the one or more fold lines comprise one or more side edge fold lines spaced to correspond with an edge of a building opening when installed.

14. The method of claim 9, further comprising bending the flexible sheet to form a 90-degree angle along a corner fold line that extends along the second direction of the flexible sheet to fit a corner of the building opening.

15. The method of claim 14, further comprising cutting the flexible sheet along a portion of the corner fold line, or along a line that intersects with the corner fold line.

16. The method of claim 14, further comprising providing a second flexible sheet having a complementary 90-degree angle that overlies the flexible sheet at the corner of the building opening.

17. The method of claim 14, further comprising:
forming a first cut along a portion of a central fold line and a second cut along a corner fold line, the first cut intersecting the second cut at a substantially perpendicular angle at the 90-degree angle to form an opening; and
receiving the upstanding V on an adjacent portion of the 90-degree angle within the opening.
